(19) United States
(12) Patent Application Publication
(10) Pub. No.: US 2019/0197539 A1
(43) Pub. Date: Jun. 27, 2019

(54) METHOD OF PROVIDING SERVICE FOR SETTING CONDITION OF CARD USE, CARD COMPANY SERVER AND USER TERMINAL

(71) Applicant: Hyundai Card Co., Ltd., Seoul (KR)

(72) Inventors: Woo Kyung CHANG, Seoul (KR); Bom Shik KIM, Seoul (KR); Hyun Jung KIM, Seoul (KR); Jin Hee PARK, Seoul (KR)

(21) Appl. No.: 15/965,011

(22) Filed: Apr. 27, 2018

(30) Foreign Application Priority Data
Dec. 27, 2017 (KR) 10-2017-0181494

(51) Int. Cl. G06Q 20/40

(52) U.S. Cl. CPC G06Q 20/405; G06Q 20/409

(57) ABSTRACT

Provided is a method of providing, by a card company server, a card service for setting a condition of card use, the method including steps of: (a) providing a user terminal with a button type interface for setting a condition of card use with respect to at least one of a use range and a use amount of a card owned by a user; (b) processing such that the condition of card use selected through the interface is set; and (c) processing such that payment approval for the owned card is completed on the basis of the set condition of card use when the payment approval is requested.

This application claims priority to and the benefit of Korean Patent Application No. 2017-0181494, filed on Dec. 27, 2017, the disclosure of which is incorporated herein by reference in its entirety.

### BACKGROUND

### 1. Field of the Invention

The present invention relates to a method of providing a service for setting a condition of card use and a card company server, and more particularly, to a method of providing a card service for setting a condition of card use, in which a button type interface for setting a condition of card use with respect to at least one of a use range and a use amount of a card owned by a user is provided such that payment approval is processed on the basis of a condition of card use selected through the interface, and a card company server.

### 2. Discussion of Related Art

Recently, as the use of cards is widespread and cards with various benefits are being released by card companies, more and more cards are being issued to users.

However, a conventional card company assigns a credit limit for an amount of use of a card to each user, and thus the user is unable to directly set the credit limit for the amount of use, and since a range of use is set when the card is issued, the user is unable to directly set the range of use, causing an inconvenience in managing a card use.

Accordingly, there is an increasing demand for a user to easily manage card use by variously setting the condition of card use on the basis of each card owned by the user, and an urgent need to improve user convenience by resolving the above discussed limitations.

### SUMMARY OF THE INVENTION

The present invention is directed to providing a method of providing a card service for setting a condition of card use, in which a button type interface for setting a condition of card use with respect to at least one of a use range and a use amount of a card owned by a user, such that payment approval is processed on the basis of a condition of card use selected through the interface, and a card company server thereof.

The technical objectives of the present invention are not limited to the above disclosure, and other objectives may become apparent to those of ordinary skill in the art based on the following descriptions.

According to one aspect of the present invention, there is provided a method of providing, by a card company server, a card service for setting a condition of card use, the method comprising steps of: (a) providing a user terminal with a button type interface for setting a condition of card use with respect to at least one of a use range and a use amount of a card owned by a user; (b) processing such that the condition of card use selected through the interface is set; and (c) processing such that payment approval for the owned card is completed on the basis of the set condition of card use when the payment approval is requested.

Step (c) may include transmitting an approval rejection message resulting from the set condition of card use to the user terminal when the payment approval for the owned card is rejected due to the set condition of card use being unsatisfied.

Step (a) may include providing the user terminal with an interface for setting a range of a used place with respect to at least one of an overseas online payment, an overseas offline payment, a domestic online payment, a domestic offline payment, and a short term card loan to be the use range of the owned card.

Step (a) may include providing the user terminal with an interface for setting a credit limit with respect to at least one of a predetermined number of times and a predetermined period of time to be the use amount of the owned card.

According to another aspect of the present invention, there is provided a method of providing, by a user terminal, a card service for setting a condition of card use, the method including steps of: (a) displaying a button type interface for setting a condition of card use with respect to at least one of a use range and a use amount of a card owned by a user; and (b) transmitting a request for setting a condition of card use that is selected through the interface to a card company server to process such that the set condition of card use is set.

The method may further include (c) receiving an approval rejection message resulting from the set condition of card use from the card company server when payment approval for the owned card is rejected due to the set condition of card use being unsatisfied, and displaying the received approval rejection message.

Step (a) may include displaying an interface for setting a range of a used place with respect to at least one of an overseas online payment, an overseas offline payment, a domestic online payment, a domestic offline payment, and a short term card loan to be the use range of the owned card.

Step (a) may include displaying an interface for setting a credit limit with respect to at least one of a predetermined number of times and a predetermined period of time to be the use amount of the owned card.

According to another aspect of the present invention, there is provided a card company server including: an interface providing unit configured to provide a user terminal with a button type interface for setting a condition of card use with respect to at least one of a use range and a use amount of a card owned by a user; a card use condition setting unit configured to process such that the condition of card use selected through the interface is set; and a payment approval unit configured to process such that payment approval for the owned card is completed on the basis of the set condition of card use when the payment approval is requested.

The payment approval unit may be configured to transmit an approval rejection message resulting from the set condition of card use to the user terminal when the payment approval for the owned card is rejected due to the set condition of card use being unsatisfied.

The interface providing unit may provide the user terminal with an interface for setting a range of a used place with respect to at least one of an overseas online payment, an overseas offline payment, a domestic online payment, a domestic offline payment, and a short term card loan to be the use range of the owned card.

The interface providing unit may provide the user terminal with an interface for setting a credit limit with respect to at least one of a predetermined number of times and a predetermined period of time to be the use amount of the owned card.

According to another aspect of the present invention, there is provided a user terminal including: a display unit configured to display a button type interface for setting a condition of card use with respect to at least one of a use range and a use amount of a card owned by a user; and a setting request unit configured to transmit a request for setting a condition of card use that is selected through the interface to a card company server to process such that the selected condition of card use is set.

The user terminal may further include: a message receiving unit configured to receive an approval rejection message resulting from the set condition of card use from the card company server when payment approval for the owned card is rejected due to the set condition of card use being unsatisfied, wherein the display unit may display the received approval rejection message.

The display unit may display an interface for setting a range of a used place with respect to at least one of an overseas online payment, an overseas offline payment, a domestic online payment, a domestic offline payment, and a short term card loan to be the use range of the owned card.

The display unit may display an interface for setting a credit limit with respect to at least one of a predetermined number of times and a predetermined period of time to be the use amount of the owned card.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a payment system according to an embodiment of the present invention;

FIG. 2 is a block diagram illustrating a configuration of a user terminal according to an embodiment of the present invention;

FIG. 3 is a block diagram illustrating a configuration of a card company server according to an embodiment of the present invention;

FIG. 4 is a diagram illustrating a process of processing payment approval through setting a condition of card use according to an embodiment of the present invention; and

FIGS. 5A to 5D are diagrams illustrating a screen of a user terminal for setting a condition of card use according to an embodiment of the present invention.

### DETAILED DESCRIPTION OF EXEMPLARY EMBODIMENTS

Hereinafter, embodiments of the present disclosure will be described in detail with reference to the accompanying drawings. The present disclosure may be embodied in various ways, and is not to be construed as limited to the embodiments set forth herein. In the drawings, parts irrelevant to the description have been omitted to clarify the explanation, and the same reference numerals have been used to designate the same elements through the whole specification.

It should be understood that when an element is referred to as being “connected” or “coupled” to another element, the element may be directly or indirectly connected or coupled to the other element, or intervening elements may be present. The terms “comprises,” “includes,” “comprising,” and/or “including” mean that described components, steps, operations, and/or elements are included and do not preclude the addition or presence of one or more other components, steps, operations, and/or elements unless the context dictates otherwise.

Hereinafter, embodiments of the present disclosure will be described in detail with reference to the accompanying drawings.

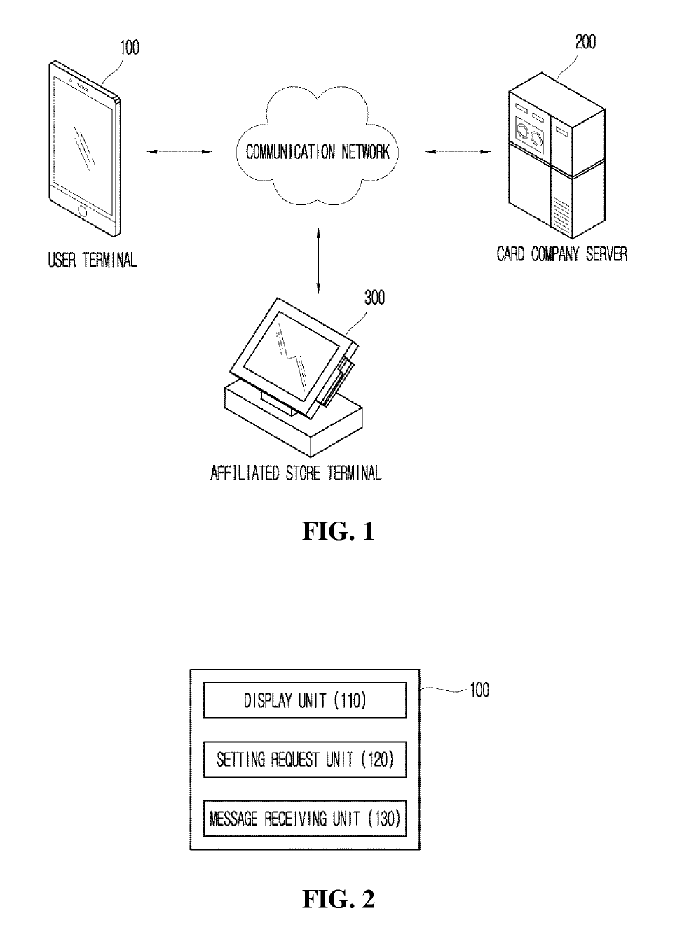

FIG. 1 is a payment system according to an embodiment of the present invention.

Referring to FIG. 1, the payment system according to the embodiment of the present invention may include a user terminal 100, a card company server 200, and an affiliated store terminal 300, which may communicate with each other through a communication network.

First, the communication network may be implemented without being limited to any communication scheme, such as a wired communication scheme or a wireless communication scheme. The communication network may be implemented through various communication networks such as a local area network (LAN), a metropolitan area network (MAN), a wide area network (WAN), and the like.

The user terminal 100 may include all types of handheld-based wireless communication devices which may be connected to an external server through a network, such as a mobile phone, a smart phone, a personal digital assistant (PDA), a portable multimedia player (PMP), a tablet personal computer (PC), and the like. In addition, the user terminal 100 may include a communication device that may be connected to an external server through a network, such as a desktop PC, a table PC, a laptop PC, and an Internet protocol television (IPTV) including a set top box.

The user terminal 100 may be provided with an application for managing a user-owned card issued to a user.

The owned card management application is an application provided by a card company that operates the card company server 200, and may provide various services related to the owned card, such as a list of owned cards, a setting of a condition of card use, and the like.

The user terminal 100 may download and install the owned card management application through an application store, and in detail, when the user terminal 100 may download the owned card management application from the card company that operates the card company server 200 and install the downloaded owned card management application in a memory of the user terminal 100.

The following description will be made in relation to a process performed by the owned card management application installed in the user terminal 100, but it should be understood that the whole process may be performed by the user terminal 100 itself without the owned card management application.

The user terminal 100 may perform a process of registering a user through a user authentication procedure when the owned card management application is initially executed, and may display a list of user-owned cards issued to the user after the user registration is completed on a screen.

The user terminal 100 may display a homepage including a card use condition setting menu on the screen when the owned card management application is executed, and may display an interface for setting a condition of card use with respect to the user owned card on the screen when the card use condition setting menu is selected.

According to an embodiment of the present invention, the condition of card use may be set such that a payment is approved only when the condition of card use is satisfied. For example, the condition of card use, such as a use range, a use amount, and the like, may be set for each of the user-owned cards.

The use range included in the condition of card use may represent a range of a used place, such as an overseas online payment, an overseas offline payment, a domestic online payment, a domestic offline payment, a short term card loan, and the like, and the use amount included in the condition of card use may represent a credit limit according to a predetermined number of times, a predetermined period of time, and the like.

The user terminal 100 may display a button type interface for setting a condition of card use with respect to at least one of the use range and the use amount of a card owned by a user while displaying the interface for setting a condition of card use on the screen.

The user terminal 100 may transmit a request for setting the condition of card use that is selected through the interface to the card company server 200 to process such that the selected condition of card use is set.

The card company server 200 is a server operated by the card company that issued the user owned card, and may store and manage information about the owned card issued to the user in a database.

When user authentication is completed in the user terminal 100, the card company server 200 may perform a user registration process on the user for whom authentication is completed, acquire the information about the owned card stored in the database, and provide the user terminal 100 with a list of user owned cards issued to the user.

The card company server 200 may provide the user terminal 100 with an interface for setting a condition of card use when the card use condition setting menu is set through the owned card management application executed on the user terminal 100.

The card company server 200 may provide the user terminal 100 with a button type interface for setting a condition of card use with respect to at least one of the use range and the use amount of the card owned by the user when the interface for setting a condition of card use is provided.

When payment approval for the owned card is requested from the affiliated store terminal 300, the card company server 200 may process such that the payment approval is completed on the basis of a preset condition of card use.

The affiliated store terminal 300 may recognize a magnetic stripe (MS) or an integrated circuit (IC) chip inside the owned card when the user owned card is inserted into a card reader connected to the affiliated store terminal 300 to identify card information, and may transmit a payment approval request including the identified card information to the card company server 200.

FIG. 2 is a block diagram illustrating a configuration of the user terminal 100 according to an embodiment of the present invention.

Referring to FIG. 2, the card company server 200 may include a display unit 110, a setting request unit 120, and a message receiving unit 130.

First, the user terminal 100 may be provided in a state in which the owned card management application is installed therein, and user registration is completed through a user authentication procedure.

The display unit 110 may display various pages provided by the owned card management application on the screen when the owned card management application is executed. In detail, the display unit 110 may display a homepage including the card use condition setting menu on the screen through execution of the owned card management application, and display a card use condition setting page on the screen when the card use condition setting menu is selected.

The display unit 110 may display a button type interface for setting a condition of card use with respect to at least one of the use range and the use amount of the card owned by the user when the card use condition setting page on the screen is displayed.

The display unit 110 may display an interface for setting a range of a used place, such as an overseas online payment, an overseas offline payment, a domestic online payment, a domestic offline payment, a short term card loan, and the like, to be the use range of the owned card on the screen when a use range setting menu is selected in the card use condition setting page.

The display unit 110 may display button type interfaces capable of determining whether to allow or restrict each of an overseas online payment, an overseas offline payment, a domestic online payment, a domestic offline payment, and a short term card loan for a used place on the screen.

The display unit 110 may display an interface for setting a credit limit according to a predetermined number of times, a predetermined period of time, and the like to be the use amount of the owned card on the screen when a use amount setting menu is selected in the card use condition setting page.

The display unit 110 may display button type interfaces for setting a card limit with respect to a predetermined number of times (for example, one time) to be the use amount and for setting a card limit with respect to a predetermined period of time (for example, one day) to be the use amount on the screen.

The setting request unit 120 may transmit a request for setting the condition of card use that is selected through the interface for setting a condition of card use to the card company server, and may process such that the selected condition of card use is set.

When a button type interface for setting a use range of an owned card for setting a condition of card use provided for each used place among the interfaces is selected, the setting request unit 120 may transmit a request for setting a condition of card use to allow a permission state of a used place to be changed through the selected interface to the card company server 200.

For example, when the button type interface for an overseas online payment is selected in a state in which button type interfaces for performing setting on use ranges of used places including an overseas online payment, an overseas offline payment, a domestic online payment, a domestic offline payment, a short term card loan, and the like are displayed on the screen of the user terminal 100 and a permission state of the used place corresponding to an overseas online payment is set to “restricted,” the setting request unit 120 may transmit a request that an overseas online payment be allowed to the card company server 200, and when the button type interface for a domestic online payment is selected in a state in which the permission state of the used place corresponding to a domestic online payment is set to “allowed,” the setting request unit 120 may transmit a request that an overseas online payment be restricted to the card company server 200.

When a button type interface provided for setting a use amount of an owned card for each of a predetermined number of times or a predetermined period of time is selected among the interfaces for setting a condition of card use, the setting request unit 120 may transmit a request for setting a condition of card use to allow a credit limit for a use amount to be changed through the selected interface to the card company server 200.

For example, button type interfaces for setting a one-time use amount on the basis of amounts of money (full credit limit, 50,000 won, 100,000 won, 300,000 won, type-in, and the like) are displayed on the screen of the user terminal 100, and, when the button type interface for 50,000 won is selected, the setting request unit 120 may transmit a request for setting a condition of card use to allow the credit limit for a one-time use amount to be set to 50,000 won to the card company server 200.

In addition, button type interfaces for setting a one-day use amount on the basis of amounts of money (full credit limit, 50,000 won, 100,000 won, 300,000 won, type-in) are displayed on the screen of the user terminal 100, and, when the button type interface for 100,000 won is selected, the setting request unit 120 may transmit a request for setting a condition of card use to allow a credit limit for a one-day use amount to be set to 100,000 won to the card company server 200.

At a time at which payment approval for the owned card is requested, the message receiving unit 130 may receive an approval completion message from the card company server 200 when the payment approval is completed as a result of the payment approval processed on the basis of the preset condition of card use, and may receive an approval rejection message from the card company server 200 when the payment approval is rejected.

When the payment approval for the owned card is rejected due to the preset condition of card use being unsatisfied, the message receiving unit 130 may receive an approval rejection message resulting from the preset condition of card use being unsatisfied from the card company server 200.

For example, when a permission state of a used place corresponding to an overseas online payment in the use range included in the condition of card use is set to “restricted,” payment approval for the owned card may be requested for a used place corresponding to an overseas online place. Since the overseas online payment is restricted, the payment approval is rejected, and thus the message receiving unit 130 may receive an approval rejection message indicating that the approval is rejected due to the restriction on the overseas online payment from the card company server 200.

In addition, when a credit limit for the one-day use amount in the use amount included in the condition of card use is set to 50,000 won, payment approval for the owned card is requested with respect to 60,000 won, an amount of money requested for the 60,000 won payment approval exceeds the credit limit for the one-day use amount of 50,000 won, and the payment approval is rejected, the message receiving unit 130 may receive an approval rejection message indicating that the approval is rejected due to the credit limit for the one-day use amount being exceeded from the card company server 200.

That is, the message receiving unit 130 may receive an approval rejection message indicating the reason for the payment approval being rejected from the card company server 200 when the payment approval for the owned card is rejected due to the preset condition of card use being unsatisfied.

The display unit 110 may display an approval completion message or an approval rejection message received from the message receiving unit 130 on the screen, and may display the approval completion message or the approval rejection as a notification message pushed to the screen.

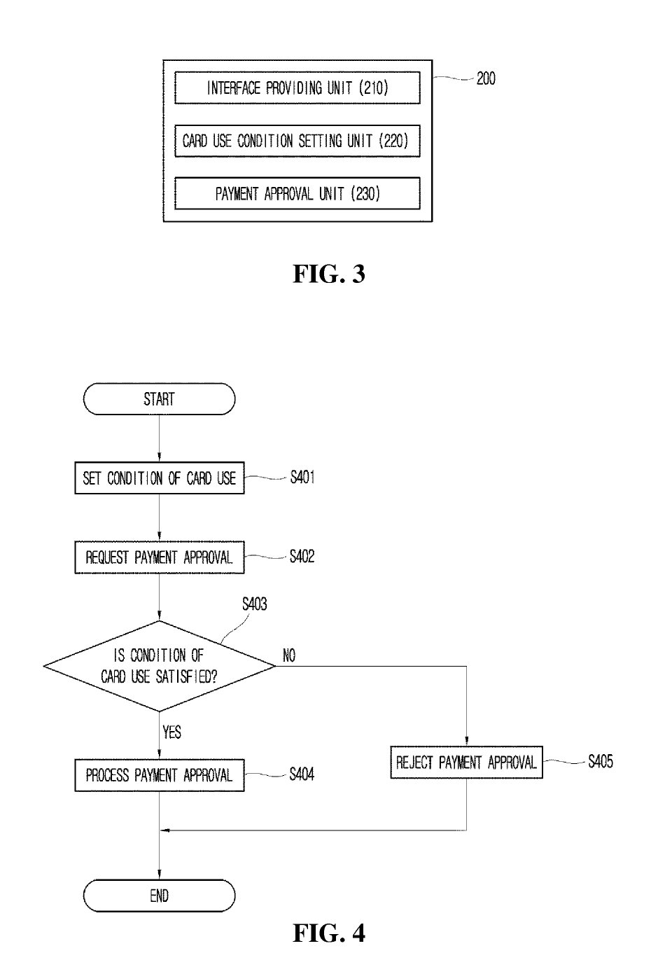

FIG. 3 is a block diagram illustrating a configuration of the card company server 200 according to an embodiment of the present invention.

Referring to FIG. 3, the card company server 200 may include an interface providing unit 210, a card use condition setting unit 220, and a payment approval unit 230.

First, when a card use condition setting menu is selected through the owned card management application executed on the user terminal 100, the interface providing unit 210 may provide the user terminal 100 with a card use condition setting page.

The interface providing unit 210 may provide the user terminal 100 with a button type interface for setting a condition of card use with respect to at least one of a use range and a use amount of a card owned by a user when the card use condition setting page is provided.

When a use range setting menu is selected in the card use condition setting page, the interface providing unit 210 may provide the user terminal 100 with an interface for setting a range of a used place, including an overseas online payment, an overseas offline payment, a domestic online payment, a domestic offline payment, and a short term card loan, to be the use range of the owned card.

The interface providing unit 210 may provide the user terminal 100 button type interfaces capable of determining whether an overseas online payment, an overseas offline payment, a domestic online payment, a domestic offline payment, and a short term card loan each are allowed or restricted for a used place.

When a use amount setting menu is selected in the card use condition setting page, the interface providing unit 210 may provide the user terminal 100 with an interface for setting a credit limit according to a predetermined number of times, a predetermined period of time, and the like to be the use amount of the owned card.

The interface providing unit 210 may provide the user terminal 100 with button type interfaces for setting a card limit with respect to a predetermined number of times (for example, one time) to be the use amount and setting a card limit with respect to a predetermined period of time (for example, one day) to be the use amount.

The card use condition setting unit 220 may process such that the selected condition of card use set through the interface for setting a condition of card use is set.

When a button type interface for setting a use range of the owned card provided for each used place among the interfaces for setting a condition of card use is selected, the card use condition setting unit 220 may set the condition of card use such that a permission state of the used place is changed through the selected interface.

For example, when the button type interface for an overseas online payment is selected in the user terminal 100 in a state in which the permission state of the used place corresponding to an overseas online payment is set to “restricted,” the interface providing unit 210 may provide the user terminal 100 with button type interfaces for performing setting on use ranges of the used places including an overseas online payment, an overseas offline payment, a domestic online payment, a domestic offline payment, a short term card loan, and the like, the card use condition setting unit 220 may change and set the permission state of the used place corresponding to an overseas online payment from “restricted” to “allowed,” and when the button type interface for a domestic online payment is selected in the user terminal 100 in a state in which the permission state of the used place corresponding to a domestic online payment is set to “allowed,” the card use condition setting unit 220 may change and set the permission state of the used place corresponding to a domestic online payment from “allowed” to “restricted.”

When a button type interface provided for setting a use amount of the owned card for each of a predetermined number of times or a predetermined period of time is selected among the interfaces for setting a condition of card use, the card use condition setting unit 220 may set the condition of card use such that a credit limit for the use amount is changed on the basis of a predetermined number of times or a predetermined period of time through the selected interface.

For example, the interface providing unit 210 may provide the user terminal 100 with button type interfaces for performing setting on a one-time use amount on the basis of amounts of money (full credit limit, 50,000 won, 100,000 won, 300,000 won, type-in, and the like), and, when the button type interface for 50,000 won is selected in the user terminal 100, the card use condition setting unit 220 may set the credit limit for the one-time use amount to 50,000 won.

In addition, the interface providing unit 210 may provide the user terminal 100 with button type interfaces for performing setting on a one-day use amount on the basis of amounts of money (full credit limit, 50,000 won, 100,000 won, 300,000 won, type-in, and the like), and, when the button type interface for 100,000 won is selected in the user terminal 100, the card use condition setting unit 220 may set the credit limit for the one-day use amount to 100,000 won.

When a request for a payment approval for the owned card is received from the affiliated store terminal 300, the payment approval unit 230 may process such that the payment approval is completed on the basis of the condition of card use set by the card use condition setting unit 220.

For example, when a request for payment approval is made from a used place corresponding to an online domestic place for the owned card in a state in which a permission state of a used place corresponding to a domestic online payment in the use range included in the condition of card use is set to “allowed,” the payment approval unit 230 may process such that the payment approval is complete because the condition of card use with respect to the use range of the owned card is satisfied.

In addition, when a payment approval for 40,000 won is requested for the owned card in a state in which a credit limit for the one-day use amount in the use amount included in the condition of card use is set to 50,000 won, the payment approval unit 230 may process such that the payment approval is completed because the condition of card use with respect to the use amount of the owned card is satisfied.

The payment approval unit 230 may transmit an approval rejection message resulting from the preset condition of card use when the payment approval for the owned card is rejected due to a failure to satisfy the condition of card use set by the card use condition setting unit 220. For example, when a permission state of a used place corresponding to an overseas online payment in the use range included in the condition of card use is set to “restricted,” a request for a payment approval for the owned card may be made from a used place corresponding to an overseas online place. Since the overseas online payment is restricted, the condition of card use with respect to the use range of the owned card is not satisfied, and thus the payment approval unit 230 may process such that the requested payment approval is rejected and transmit an approval rejection message indicating that the approval is rejected due to the rejection of the overseas online payment to the user terminal 100.

In addition, when a credit limit for the one-day use amount in the use amount included in the condition of card use is set to 50,000 won, a payment approval for 60,000 won may be requested for the owned card. Since the amount of money requested for the payment approval for 60,000 won exceeds the credit limit for the one-day use amount of 50,000 won, the payment approval unit 230 may process such that the payment approval is rejected and transmit an approval rejection message indicating that the approval is rejected due to the credit limit for the one-day use amount being exceeded to the user terminal 100.

That is, when the payment approval for the owned card is rejected due to the preset condition of card use being unsatisfied, the payment approval unit 230 may transmit an approval rejection message indicating a reason for the payment approval being rejected to the user terminal 100.

FIG. 4 is a diagram illustrating a process of processing payment approval through setting a condition of card use according to an embodiment of the present invention.

First, when an owned card management application installed in the user terminal 100 is executed, a card use condition setting menu may be provided, and the card company server 200 may provide the user terminal 100 with a card use condition setting page for performing setting on at least one of a use range and a user amount of an owned card when the card use condition setting menu is selected in the user terminal 100.

When the card use condition setting page for performing setting on the use range of the owned card is provided, the card company server 200 may provide the user terminal 100 with button type interfaces for setting a range of a used place with respect to at least one of an overseas online payment, an overseas offline payment, a domestic online payment, a domestic offline payment, and a short term card to be the use range of the owned card.

When the card use condition setting page for performing setting on the use amount of the owned card is provided, the card company server 200 may provide the user terminal 100 with button type interfaces for setting a credit limit with respect to at least one of a plurality of number of times and a predetermined period of time to be the use amount of the owned card. When a request for setting a condition of card use is made through the interface included in the card use condition setting page, the card company server 200 may process such that the requested condition of card use is set during an operation of setting a condition of card use (S401).

In detail, when a button type interface for setting a use range of the owned card provided for each used place is selected in the card use condition setting page, the card company server 200 may set the condition of card use such that a permission state of the used place is changed through the selected interface.

In addition, when a button type interface provided for setting a use amount of the owned card for each of a predetermined number of times or a predetermined period of time is selected in the card use condition setting page, the card company server 200 may set the condition of card use such that a credit limit for the use amount is changed on the basis of a predetermined number of times or a predetermined period of time through the selected interface.

Then, a user may request payment approval for the card owned by the user in an operation of requesting a payment approval (S402). In this case, when the card payment is requested online, information about the owned card is input online such that the payment approval is requested, and, when the card payment is requested offline, the owned card is recognized by the affiliated store terminal 300 such that the payment approval is requested.

The affiliated store terminal 300 may acquire information about the owned card by recognizing a plastic card through a card recognition unit included in the affiliated store terminal 300 when the card owned by the user is a plastic card, may acquire information about the owned card by recognizing bar code information corresponding to a mobile card through a bar code recognition unit included in the affiliated store terminal 300 when the card owned by the user is the mobile card, and may transmit a payment approval request including the acquired information about the owned card to the card company server 200.

Then, the card company server 200 may verify whether the payment approval request made for the owned card satisfies the condition of card use in an operation of verifying whether the condition of card use is satisfied (S403).

In detail, the card company server 200 may identify a used place from which the payment approval is requested through information about an affiliated store included in the payment approval request, and may determine whether the affiliated store is included as a used place within the use range of the owned card, thereby verifying whether the payment approval request made for the owned card satisfies the condition of card use.

For example, when a request for payment approval for the owned card is made from a domestic online affiliated store, the card company server 200 may determine whether a permission state of a used place corresponding to a domestic online payment is “allowed” or “restricted,” thereby verifying whether the condition of card use is satisfied.

In addition, the card company server 200 may identify an amount of money requested for the payment approval via payment approval amount information included in the payment approval request, and may check whether a remaining credit limit with respect to a predetermined number of times or a predetermined period of time of the owned card is as much as the amount of money requested for the payment approval, thereby verifying whether the payment approval request made for the owned card satisfies the condition of card use.

For example, when a payment approval for 60,000 won is requested for the owned card, the card company server 200 may check whether the remaining card limit for the one-day use amount is as much as 60,000 won, thereby verifying whether the condition of card use is satisfied.

When it is determined that the condition of card use is satisfied as a result of verification of the condition of card use, the card company server 200 may process such that the payment approval requested for the owned card is completed in an operation of processing payment approval (S404).

When it is not determined that the condition of card use is satisfied as a result of verification of the condition of card use, the card company server 200 may process such that the payment approval requested for the owned card is rejected in an operation of rejecting a payment approval (S405).

When the payment approval requested for the owned card is rejected due to a preset condition of card use being unsatisfied, the card company server 200 may transmit an approval rejection message indicating a reason for the rejection resulting from the condition of card use to the user terminal 100.

For example, when approval is rejected due to a restriction of an overseas online payment, the card company server 200 may transmit an approval rejection message indicating that the approval is rejected due to the restriction of an overseas online payment to the user terminal 100, and, when approval is rejected due to a credit limit for a one-day use amount being exceeded, the card company server 200 may transmit an approval rejection message indicating that the approval is rejected due to the credit limit for a one-day use amount being exceeded to the user terminal 100.

That is, according to an embodiment of the present invention, the approval rejection message may be transmitted in the form of a short message service (SMS) and a multi-media message (MMS), and the approval rejection message may include a uniform resource location (URL) linked to a card use condition setting page so that the user terminal 100 may connect to the card use condition setting page through the owned card management application or a web browser when the URL included in the approval rejection message is selected and display the card use condition setting page on a screen.

That is, the user may change the setting of the condition of card use immediately after identifying the reason that the approval is rejected and process a subsequent payment approval request such that it is prevented from being rejected.

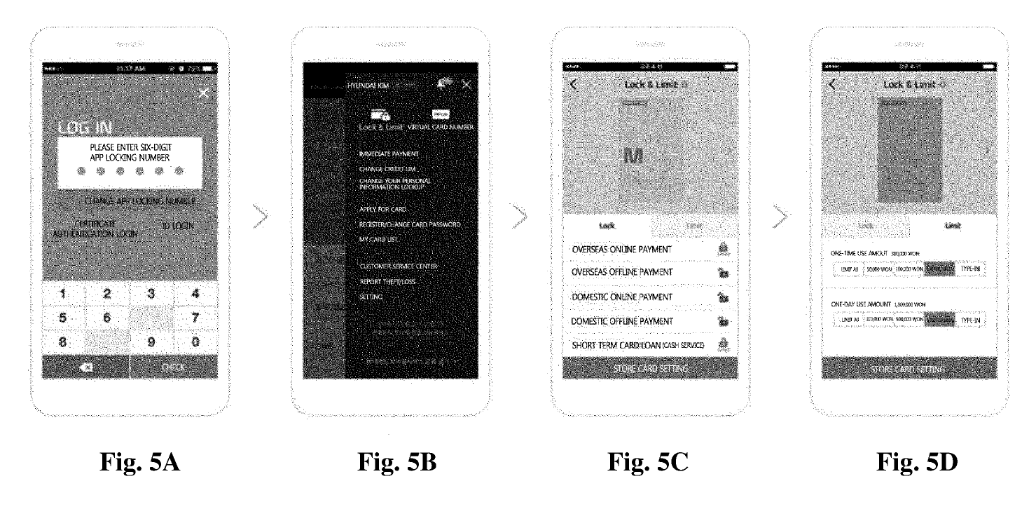

FIGS. 5A to 5D are diagrams illustrating a screen of the user terminal 100 for setting a condition of card use according to an embodiment of the present invention.

First, when an owned card management application installed in the user terminal 100 is executed, the user terminal 100 may display a login page shown in FIG. 5A on the screen.

When a login procedure is completed by a password and the like being input, the user terminal 100 may display a homepage provided by the owned card management application on the screen, and, the user terminal 100 may display a menu list page as shown in FIG. 5B on the screen when a menu list view button is selected in the homepage.

When a card use condition setting menu button (for example, a “Lock” button or a “Limit” button) is selected in the menu list page, the user terminal 100 may display a card use condition setting page on the screen, in detail, a use range setting page for setting a use range included in the condition of card use or a use amount setting page for setting a use amount included in the condition of card use.

That is, the user terminal 100 may display a use range setting page shown in FIG. 5C or a use amount setting page shown in of FIG. 5D on the screen to allow the condition of card use to be set.

According to an embodiment of the present invention, the use range setting page and the use amount setting page may be implemented on individual pages, or implemented on a single page.

In a case in which the use range setting page and the use amount setting page are implemented on individual pages, when a use amount setting menu (the “Limit” button) is selected in a state in which the use range setting page is displayed on the screen, the use range setting page is converted into the use amount setting page, and conversely, when a use range setting menu (the “Lock” button) is selected in a state in which the use amount setting page is displayed on the screen, the use amount setting page is converted into the use range setting page.

The use range setting page includes button type interfaces representing permission states of used places, such as an overseas online payment, an overseas offline payment, a domestic online payment, a domestic offline payment, a short term card loan, and the like, and the permission state of the used place is changed and set through the selected interface when a corresponding interface is selected.

For example, in a case in which the permission state of the used place corresponding to an overseas online payment is set to “restricted,” a button type interface representing the permission state of the used place for an overseas online payment is indicated in the form of a closed lock. When the interface is selected, the permission state of the used place corresponding to the overseas online payment is changed from “restricted” to “allowed,” and thus the button type interface representing the permission state of the used place for an overseas online payment is indicated in the form of an open lock.

That is, by only selecting the button type interface provided for each of the used places, the permission state of the used place of the owned card may be immediately changed and set.

The use amount setting page includes button type interfaces for setting a credit limit on the basis of a predetermined number of times or a predetermined period of time, and, when the interface is selected, the credit limit for use amount may be changed and set through the selected interface.

For example, button type interfaces for setting a credit limit of a one-time use amount may be provided on the basis of amounts of money, e.g., full credit limit, 50,000 won, 100,000 won, 300,000 won, type-in, and the like, and, when the credit limit of the one-time use amount time is set to 300,000 won, only the button type interface for 300,000 won is enabled, as shown in FIG. 5D.

When the button type interface representing 100,000 won is selected, the one-time use amount of the credit limit of 300,000 won is changed and set to 100,000 won, and thus the button type interface representing 300,000 won is disabled and only the button type interface representing 100,000 won is enabled.

That is, by only selecting the button type interface provided for each of the amounts of money corresponding to a predetermined number of times or a predetermined period of time, the credit limit for the use amount of the owned card is immediately changed and set.

According to an embodiment of the present invention, when a plurality of owned cards are issued to the user, a condition of card use may be set for each of the plurality of owned cards and a list of the owned cards issued to the user is displayed through the owned card management application so that a card use condition setting page for an owned card selected from the list of owned cards is provided.

For example, FIG. 5C shows a use range setting page for a first owned card, and when a part in which the first owned card is displayed is slid to one side, a use range setting page for a second owned card is displayed such that a use range of the second owned card is settable.

Similarly, FIG. 5D shows a use amount setting page for the first owned card, and when a part in which the first owned card is displayed is slide to one side, a use amount setting page for the second owned card is displayed such that a use amount of the second owned card is settable.

As is apparent from the above, a user variously may set a condition of card use with respect to at least one of a use range and a use amount on the basis of each card owned by the user, and thus a financial accident and excessive card use can be prevented.

In addition, according to the embodiment of the present invention, a condition of card use with respect to a use range and a use amount may be set through a button type interface, and thus the condition of card use is settable by only selecting a button type interface such that user convenience can be improved.

In addition, according to the embodiment of the present invention, when card payment approval is rejected due to a preset condition of card use being unsatisfied, a notification service is provided in which an approval rejection message resulting from the preset condition of card use is transmitted to a user terminal so that a user is immediately informed of the reason of the approval rejection.

It should be understood that the effects of the present disclosure are not limited to the above effects and include all effects that can be deduced from the detailed description of the present disclosure or the configuration of the present disclosure described in the claims.

The above description of the present disclosure is for illustrative purposes, and a person having ordinary skilled in the art should appreciate that other specific modifications may be easily made without departing from the technical spirit or essential features of the present disclosure. Therefore, the above embodiments should be regarded as illustrative rather than limitative in all aspects. For example, components described as being a single unit may be embodied in a distributed form, and components described as being distributed can be embodied in a combined form.

The scope of the present disclosure is not defined by the detailed description set forth above, but by the accompanying claims of the present disclosure. It should also be understood that all changes or modifications derived from the definitions and scope of the claims and their equivalents fall within the scope of the present disclosure.

What is claimed is:

1. A method of providing, by a card company server, a card service for setting a condition of card use, the method comprising steps of:
(a) providing a user terminal with a button type interface for setting a condition of card use with respect to at least one of a use range and a use amount of a card owned by a user;
(b) processing such that the condition of card use selected through the interface is set; and
(c) processing such that payment approval for the owned card is completed on the basis of the set condition of card use when the payment approval is requested.

2. The method of claim 1, wherein step (c) comprises transmitting an approval rejection message resulting from the set condition of card use to the user terminal when the payment approval for the owned card is rejected due to the set condition of card use being unsatisfied.

3. The method of claim 1, wherein step (a) comprises providing the user terminal with an interface for setting a range of a used place with respect to at least one of an overseas online payment, an overseas offline payment, a domestic online payment, a domestic offline payment, and a short term card loan to be the use range of the owned card.

4. The method of claim 1, wherein step (a) comprises providing the user terminal with an interface for setting a credit limit with respect to at least one of a predetermined number of times and a predetermined period of time to be the use amount of the owned card.

5. A method of providing, by a user terminal, a card service for setting a condition of card use, the method comprising steps of:
(a) displaying a button type interface for setting a condition of card use with respect to at least one of a use range and a use amount of a card owned by a user; and
(b) transmitting a request for setting a condition of card use that is selected through the interface to a card company server to process such that the set condition of card use is set.

6. The method of claim 5, wherein further comprising (c) receiving an approval rejection message resulting from the set condition of card use from the card company server when payment approval for the owned card is rejected due to the set condition of card use being unsatisfied, and displaying the received approval rejection message.

7. The method of claim 5, wherein step (a) comprises displaying an interface for setting a range of a used place with respect to at least one of an overseas online payment, an overseas offline payment, a domestic online payment, a domestic offline payment, and a short term card loan to be the use range of the owned card.

8. The method of claim 5, wherein step (a) comprises displaying an interface for setting a credit limit with respect to at least one of a predetermined number of times and a predetermined period of time to be the use amount of the owned card.

9. A card company server comprising:
an interface providing unit configured to provide a user terminal with a button type interface for setting a condition of card use with respect to at least one of a use range and a use amount of a card owned by a user;
a card use condition setting unit configured to process such that the condition of card use selected through the interface is set; and
a payment approval unit configured to process such that payment approval for the owned card is completed on the basis of the set condition of card use when the payment approval is requested.

10. The card company server of claim 9, wherein the payment approval unit is configured to transmit an approval rejection message resulting from the set condition of card use to the user terminal when the payment approval for the owned card is rejected due to the set condition of card use being unsatisfied.

11. The card company server of claim 9, wherein the interface providing unit provides the user terminal with an interface for setting a range of a used place with respect to at least one of an overseas online payment, an overseas offline payment, a domestic online payment, a domestic offline payment, and a short term card loan to be the use range of the owned card.

12. The card company server of claim 9, wherein the interface providing unit provides the user terminal with an interface for setting a credit limit with respect to at least one of a predetermined number of times and a predetermined period of time to be the use amount of the owned card.

13. A user terminal comprising:
a display unit configured to display a button type interface for setting a condition of card use with respect to at least one of a use range and a use amount of a card owned by a user; and
a setting request unit configured to transmit a request for setting a condition of card use that is selected through the interface to a card company server to process such that the selected condition of card use is set.

14. The user terminal of claim 13, further comprising a message receiving unit configured to receive an approval rejection message resulting from the set condition of card use from the card company server when payment approval for the owned card is rejected due to the set condition of card use being unsatisfied,
wherein the display unit displays the received approval rejection message.

15. The user terminal of claim 13, wherein the display unit displays an interface for setting a range of a used place with respect to at least one of an overseas online payment, an overseas offline payment, a domestic online payment, a domestic offline payment, and a short term card loan to be the use range of the owned card.

16. The user terminal of claim 13, wherein the display unit displays an interface for setting a credit limit with respect to at least one of a predetermined number of times and a predetermined period of time to be the use amount of the owned card.
